(19) United States
(12) Patent Application Publication
(10) Pub. No.: US 2003/0059711 A1
(43) Pub. Date: Mar. 27, 2003

(54) Rewritable optical data storage medium and use of such a medium

(75) Inventors: Martijn Henri Richard Lankhorst, Eindhoven (NL); Johannes Cornelis Norbertus Rijpers, Eindhoven (NL); Hermanus Johannes Borg, Eindhoven (NL); Johannes Henricus Josephus Roosen, Eindhoven (NL)

Correspondence Address: U.S. Philips Corporation, 580 White Plains Road, Tarrytown, NY, 10591, US

(73) Assignee: Koninklijke Philips Electronics N.V.

(21) Appl. No.: 10/117,852

(22) Filed: Apr. 8, 2002

(30) Foreign Application Priority Data
Apr. 12, 2001 (EP) 01201347.0

(51) Int. Cl. G11B 7/24

(52) U.S. Cl. 430/270.13; 369/275.2; 369/275.5; 430/945; 428/64.5

(57) ABSTRACT

A description is given of a rewritable optical data storage medium having a phase-change recording layer on the basis of an alloy of Ga-In-Sb, which composition is situated within the pentagonal area TUVW in a triangular ternary composition diagram. These alloys show an amorphous phase stability of 10 year or more at 30° C. Such a medium is suitable for high speed recording, e.g. at least 30 Mbits/sec, such as DVD+RW, DVD−RW, DVD-RAM, high speed CD-RW, DVR-red and DVR-blue.

The invention relates to a rewritable optical data storage medium for high-speed recording by means of a laser-light beam, said medium comprising a substrate carrying a stack of layers, which stack comprises, a first dielectric layer, a second dielectric layer, and a recording layer of a phase-change material having an alloy comprising Ga, In and Sb, said recording layer being interposed between the first and the second dielectric layer.

The invention also relates to the use of such an optical data storage medium in high data rate and high data stability applications.

An embodiment of an optical data storage medium of the type mentioned in the opening paragraph is known from European patent EP 0387898 B1.

An optical data storage medium based on the phase change principle is attractive, because it combines the possibilities of direct overwrite (DOW) and high storage density with easy compatibility with read-only optical data storage systems. Phase-change optical recording involves the formation of submicrometer-sized amorphous recording marks in a crystalline recording layer using a focused relatively high power laser-light beam. During recording of information, the medium is moved with respect to the focused laser-light beam that is modulated in accordance with the information to be recorded. Marks are formed when the high power laser-light beam melts the crystalline recording layer. When the laser-light beam is switched off and/or subsequently moved relatively to the recording layer, quenching of the molten marks takes place in the recording layer, leaving an amorphous information mark in the exposed areas of the recording layer that remains crystalline in the unexposed areas. Erasure of written amorphous marks is realized by recrystallization through heating with the same laser at a lower power level, without melting the recording layer. The amorphous marks represent the data bits, which can be read, e.g. via the substrate, by a relatively low-power focused laser-light beam. Reflection differences of the amorphous marks with respect to the crystalline recording layer bring about a modulated laser-light beam which is subsequently converted by a detector into a modulated photocurrent in accordance with the recorded information.

One of the most important demands in phase-change optical recording is a high data rate, which means that data can be written and rewritten in the medium with a user data rate of at least 30 Mbits/s. Such a high data rate requires the recording layer to have a high crystallization speed, i.e. a short crystallization time, during DOW. To ensure that previously recorded amorphous marks can be recrystallized during DOW, the recording layer must have a proper crystallization speed to match the velocity of the medium relative to the laser-light beam. If the crystallization speed is not high enough the amorphous marks from the previous recording, representing old data, cannot be completely erased, meaning recrystallized, during DOW. This causes a high noise level. A high crystallization speed is particularly required in high-density recording and high data rate optical recording media, such as in disc-shaped CD-RW high speed, DVD−RW, DVD+RW, DVD-RAM, DVR-red and blue which are abbreviations of a new generation high density Digital Versatile Disc+RW, where RW refers to the rewritability of such discs, and Digital Video Recording optical storage discs, where red and blue refer to the used laser wavelength. For these discs the complete erasure time (CET) has to be lower than 30 ns. CET is defined as the minimum duration of an erasing pulse for complete crystallization of a written amorphous mark in a crystalline environment, which is measured statically. For DVD+RW, which has a 4.7 GB recording density per 120 mm disk, a user data bit rate of 26 Mbits/s is needed, and for DVR-blue said rate is 35 Mbits/s. For high speed versions of DVD+RW and DVR-blue data rates of 50 Mbits/s and higher are required. Another very important demand in phase-change optical recording is a high data stability, which means that recorded data remain intact for a long period of time. A high data stability requires the recording layer to have a low crystallization rate, i.e. a long crystallization time, at temperatures below 100° C. Data stability may be specified e.g. at a temperature of e.g. 30° C. During archival storage of the optical data storage medium, written amorphous marks recrystallize at a certain rate, which is determined by the properties of the recording layer. When marks are recrystallized they cannot be distinghuised anymore from the crystalline surrounding, in other words: the mark is erased. For practical purposes a recrystallization time of at least 10 years at room temperature, i.e. 30° C., is needed.

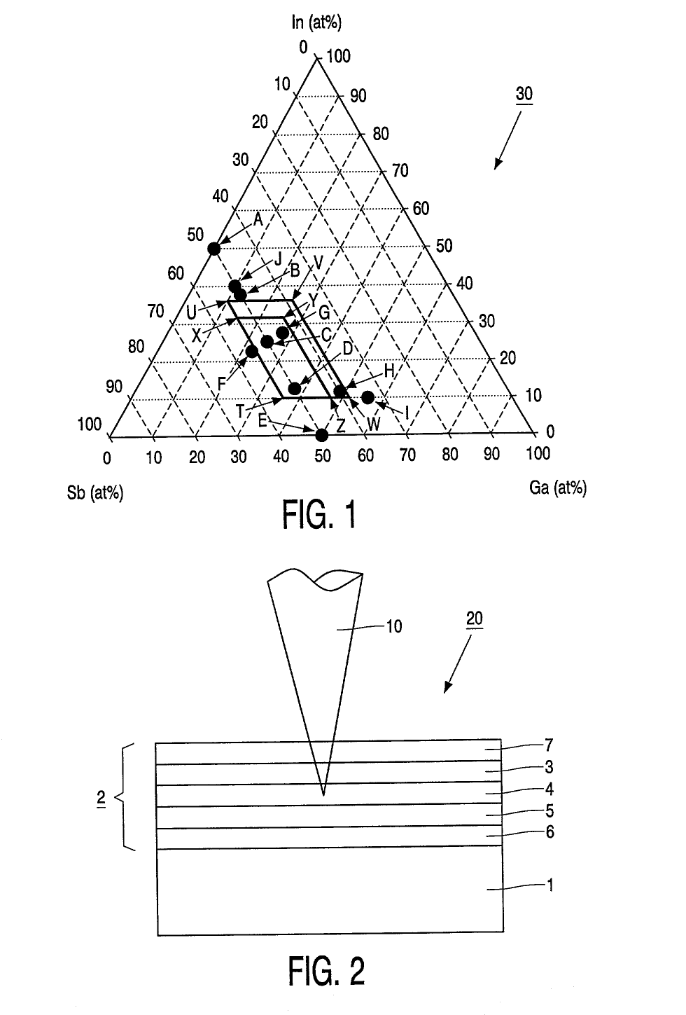

In European patent EP 0387898 B1 the medium of the phase-change type comprises a disc-shaped substrate of an acrylic resin having thereon a 100 nm thick first dielectric layer of SiO₂, a 100 nm-thick recording material layer of a phase-change alloy, and a 100 nm thick second dielectric layer. Such a stack of layers can be referred to as an IPI-structure, wherein I represents a dielectric layer and P represents a phase-change recording layer. Said patent discloses a recording layer of the composition (InSb)₈₀(GaSb)₂₀, which has time of crystallization of smaller than 100 ns and a crystallization temperature of larger than 120° C. Modeling by Applicants shows that this corresponds to a crystallization time of about 0.6 year at 30° C. (see example J in table 2). According to present standards such a crystallization time is by far not large enough in order to be usable as a recording layer in a stable medium. For complete erasure of an amorphous mark, two processes are known, i.e. crystallization by nucleation and crystallization by grain crystallite growth. Nucleation of crystallites is a process where nuclei of crystallites are spontaneously and randomly formed in the amorphous material. Therefore the probability of nucleation depends on the volume, e.g. thickness, of the recording material layer. Grain growth crystallization may occur when crystallites are already present, e.g. the crystalline surroundings of an amorphous mark or crystallites which have been formed by nucleation. Grain growth involves the growth of those crystallites by crystallization of amorphous material adjacent the already present crystallites. In practice both mechanisms may occur in parallel but generally one mechanism dominates over the other in terms of efficiency or speed. The term, which is most frequently used, for defining the crystallization time is complete erasure time. The complete erase time (CET) is defined as the minimum duration of the erasing pulse for complete crystallization of a written amorphous mark in a crystalline environment, which is measured statically. The time mentioned in said patent is the CET. Said patent teaches that the composition (InSb)₈₀(GaSb)₂₀ has a CET of smaller than 100 ns. Experiments by the current Applicant show that this compound has a CET-value of 25 ns. Said composition is represented by a J in the ternary composition diagram Ga-In-Sb of FIG. 1.

It is an object of the invention to provide an optical data storage medium of the kind described in the opening paragraph, which is suitable for high data rate optical recording, such as DVR-blue, having an environmental data stability of 10 years or more at a temperature of 30° C.

This object is achieved in that the ratio of Ga, In and Sb in the alloy is represented by an area in the ternary composition diagram Ga-In-Sb in atomic percentages, said area being of quadrangular shape having the following vertices T, U, V and W:

| | |
|---|---|
| Ga₃₆In₁₀Sb₅₄ | (T) |
| Ga₁₀In₃₆Sb₅₄ | (U) |
| Ga₂₆In₃₆Sb₃₈ | (V) |
| Ga₅₂In₁₀Sb₃₈ | (W). |

Surprisingly, the alloys comprising compositions within the quadrangularly shaped area TUVW in the triangular ternary Ga-In-Sb composition diagram (see FIG. 1) show an archival stability which is much better than alloys comprising compositions outside area TUVW. Several experiments have shown that the compositions in these alloys which are situated to the right of the straight line crossing the vertices V and W and above the straight line crossing the vertices U and V have stability values which are far worse than the values at the other sides of these lines. It was further found that compositions in these alloys which are situated to the left of the imaginary straight line crossing the vertices T and U are very stable but have a CET of 50 ns or larger which is undesirable from a viewpoint of achievable DOW data rate of the optical data storage medium. Further compositions in these alloys below the straight line crossing T and W have shown to be relatively insensitive to laser-light power. This means that a relatively large amount of laser-light power is needed in order to successfully write or rewrite data in the optical data storage medium, especially at high data rates which require a larger medium speed relatively to the laser-light beam. At larger write and rewrite speeds more laser-light power is needed. In most cases semiconductor lasers are used for generating the laser-light beam. Especially at shorter laser light wavelengths, e.g. lower than 700 nm, the maximum laser power of those lasers is limited and poses a barrier for high recording powers.

Especially useful are alloys which are characterized in that the ratio of Ga, In and Sb in the alloy is represented by an area in the ternary composition diagram Ga-In-Sb in atomic percentages, said area being of quadrangular shape having the following vertices T, X, Y and Z:

| | |
|---|---|
| Ga₃₆In₁₀Sb₅₄ | (T) |
| Ga₁₄In₃₂Sb₅₄ | (X) |
| Ga₂₅In₃₂Sb₄₃ | (Y) |
| Ga₄₇In₁₀Sb₄₃ | (Z). |

These alloys have the additional advantage that the stability is even better while the maximum CET is still lower than 25 ns. Compositions in said area are stable at least 50 years at 30° C.

In a further refinement of the medium according to the invention the first dielectric layer comprises the compound SiH_{y} and is present adjacent the recording layer, and in which y satisfies 0≦y≦0.5. Using this material as the first dielectric layer has the advantage that the optical contrast of the recording layer is enhanced. The optical contrast M₀ is defined as |R_{c}−Rₐ|/Rₕ, where R_{c} and Rₐ are the reflections of the recording layer material in the crystalline and amorphous state respectively and Rₕ is the largest of R_{c} and Rₐ. The optical contrast is an important parameter for reliable read out because it increases the signal strength of the read out signal and thus the signal to noise ratio. The improvement can be explained by the fact that the real part of the refractive index of the compound SiH_{y} substantially matches the value of the real part of the refractive index of the recording layer in both amorphous and crystalline state. This causes that the relative difference in the imaginary part of the refractive indices of the amorphous and crystalline state is enhanced.

A further advantage of using a SiH_{y} layer is that optimal optical contrast requires that the recording layer has a thickness of at least 30 nm. This possibility of using a thicker recording layer has the effect that the nucleation rate is increased because of the larger volume of the layer. The probability of nucleation is increased. A higher nucleation rate increases the crystallization speed of the material and even higher date rates, e.g. during DOW, may be achieved. Normally, using a thicker recording layer without an adjacent SiH_{y} layer would decrease the optimal optical contrast.

The crystallization speed can be further increased when the recording layer is in contact with at least one additional carbide layer, having a thickness between 2 and 8 nm. The above materials are used in a stack II⁺PI⁺I or II⁺PI, where I⁺ is a carbide. Alternatively a nitride or an oxide may be used. In the II⁺PI⁺I stack the recording layer P is sandwiched between a first and a second carbide layer I⁺. The carbide of the first and the second carbide layer is preferably a member of the group SiC, ZrC, TaC, TiC, and WC, which combine an excellent cyclability with a short CET. SiC is a preferred material because of its optical, mechanical and thermal properties; moreover, its price is relatively low. Experiments show that the CET-value of an II⁺PI⁺I stack is less than 60% of that of an IPI stack. The thickness of the additional carbide layer is preferably between 2 and 8 nm. The relatively high thermal conductivity of the carbide will only have a small effect on the stack when this thickness is small, thereby facilitating the thermal design of the stack. In case a SiH_{y} layer is used as first dielectric layer, a carbide layer between the first dielectric layer and the recording layer does not or hardly influence the optical contrast because of its relatively low thickness.

In another embodiment a metal reflective layer is present adjacent the second dielectric layer at a side remote from the first dielectric layer. In this way a so-called IPIM structure, or in combination with additional I⁺ layers, an II⁺PI⁺IM structure, is formed. The additional metal layer may serve to increase the total reflection of the stack and/or the optical contrast. Furthermore it serves as a heat sink in order to increase the cooling rate of the recording layer during the formation of amorphous marks. The metal reflective layer comprises at least one of the metals selected from a group consisting of Al, Ti, Au, Ag, Cu, Pt, Pd, Ni, Cr, Mo, W and Ta, including alloys of these metals.

The second dielectric layer, i.e. the layer between the metal reflective layer and the phase-change recording layer, protects the recording layer from the influence of e.g. the metal reflective layer and/or further layers, and optimizes optical contrast and thermal behavior. For optimal optical contrast and thermal behavior the thickness of the second dielectric layer is preferably in the range of 10-30 nm. In view of the optical contrast, the thickness of this layer may alternatively be chosen to be λ/(2n) nm thicker, wherein X is the wavelength of the laser-light beam in nm, and n is the refractive index of the second dielectric layer. However, choosing a higher thickness will reduce the cooling influence of the metal reflective or further layers on the recording layer. An optimum thickness range for the first dielectric layer, i.e. the layer through which the laser-light beam enters first, is determined by a.o. the laser-light beam wavelength λ. When λ=670 nm an optimum is found around 120 nm. In case SiH_{y} is used the layer has an optimal thickness of 65 nm at λ=670 nm. Again, alternatively, the thickness of this layer may be chosen to be λ/(2n)=670/2*3.85=87 nm thicker, e.g. a thickness of 65+87=152 nm.

The first and second dielectric layers may be made of a mixture of ZnS and SiO₂, e.g. (ZnS)₈₀(SiO₂)₂₀. Alternatives are, e.g. SiO₂, TiO₂, ZnS, AIN, Si₃N₄ and Ta₂O₅. Preferably, a carbide is used, like SiC, WC, TaC, ZrC or TiC. These materials give a higher crystallization speed and better cyclability than a ZnS-SiO₂ mixture.

Both the reflective layers and the dielectric layers can be provided by vapor deposition or sputtering.

The substrate of the data storage medium consists, for example, of polycarbonate (PC), polymethyl methacrylate (PMMA), amorphous polyolefin or glass. In a typical example, the substrate is disc-shaped and has a diameter of 120 mm and a thickness of 0.1, 0.6 or 1.2 mm. When a substrate of 0.6 or 1.2 mm is used, the layers can be applied on this substrate starting with the first dielectric layer. If the laser-light enters the stack via the substrate, said substrate must be at least transparent to the laser-light wavelength. The layers of the stack on the substrate may also be applied in the reversed order, i.e. starting with the second dielectric layer or metal reflective layer, in which case the laser-light beam will not enter the stack through the substrate. Optionally an outermost transparent layer may be present on the stack as a cover layer that protects the underlying layers from the environment. This layer may consist of one of the above mentioned substrate materials or of a transparent resin, for example, an UV light-cured poly(meth)acrylate with, for example, a thickness of 100 μm. Such a relatively thin cover layer allows a high numerical aperture (NA) of the focused laser-light beam, e.g. NA=0.85. A thin 100 μm cover layer is e.g. used for the DVR disc. If the laser-light beam enters the stack via the entrance face of this transparent layer, the substrate may be opaque.

The surface of the substrate of the optical data storage medium on the side of the recording layer is, preferably, provided with a servotrack that may be scanned optically with the laser-light beam. This servotrack is often constituted by a spiral-shaped groove and is formed in the substrate by means of a mould during injection molding or pressing. This groove may alternatively be formed in a replication process in a synthetic resin layer, for example, of an UV light-cured layer of acrylate, which is separately provided on the substrate. In high-density recording such a groove has a pitch e.g. of 0.5-0.8 μm and a width of about half the pitch.

High-density recording and erasing can be achieved by using a short-wavelength laser, e.g. with a wavelength of 670 nm or shorter (red to blue).

The phase-change recording layer can be applied to the substrate by vapor depositing or sputtering of a suitable target. The layer thus deposited is amorphous. In order to constitute a suitable recording layer this layer must first be completely crystallized, which is commonly referred to as initialization. For this purpose, the recording layer can be heated in a furnace to a temperature above the crystallization temperature of the Ga-In-Sb alloy, e.g. 180° C. A synthetic resin substrate, such as polycarbonate, can alternatively be heated by a laser-light beam of sufficient power. This can be realized, e.g. in a recorder, in which case the laser-light beam scans the moving recording layer. The amorphous layer is then locally heated to the temperature required for crystallizing the layer; while preventing that the substrate is being subjected to a disadvantageous heat load.

The invention will be elucidated in greater detail by means of exemplary embodiments and with reference to the accompanying drawings, in which

FIG. 1 shows the triangular ternary composition diagram Ga-In-Sb in atom %, in which a two quadrangular areas TUVW and TXYZ as well as points A to J are indicated,

FIG. 2 shows a schematic cross-sectional view of an optical data storage medium in accordance with the invention,

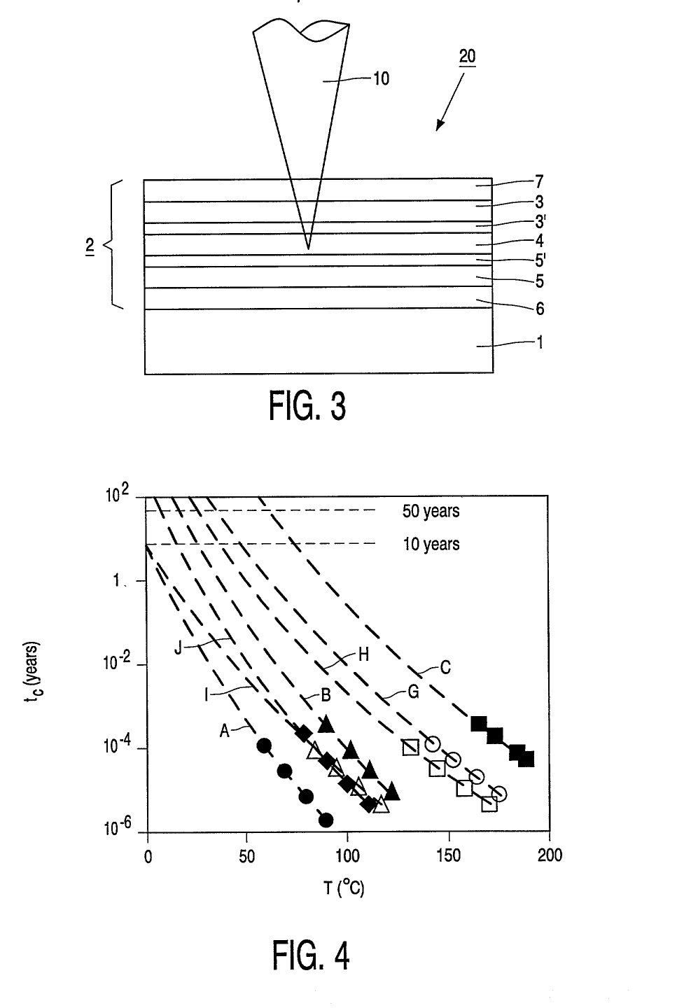

FIG. 3 shows another schematic cross-sectional view of an optical data storage medium in accordance with the invention, and

FIG. 4 shows a graphical representation of the data stability or crystallization time (t_{c}) of the amorphous phase marks of points A, B, C, G, H, I and J as indicated in FIG. 1 as a function of temperature (T in ° C.).

### EXAMPLES C, D, G, and H

### According to the Invention

In FIG. 2 the rewritable optical data storage medium for high-speed recording by means of a laser-light beam 10 has a substrate 1 and a stack 2 of layers provided thereon. The stack 2 has a first dielectric layer 3 made of (ZnS)₈₀(SiO₂)₂₀ having a thickness of 120 nm, a second dielectric layer 5 made of (ZnS)₈₀(SiO₂)₂₀ having a thickness of 20 nm and a recording layer 4 of a phase-change material having an alloy comprising Ga, In and Sb. The recording layer 4, having a thickness of 25 nm, is interposed between the first dielectric layer 3 and the second dielectric layer 5. The ratio of Ga, In and Sb in the alloy is represented by points C, D, G and H in the ternary composition diagram of FIG. 1. The exact compositions are indicated in Table 1.

A metal reflective layer 6 of A1, having a thickness of 100 nm, is present adjacent the second dielectric layer 5 at a side remote from the first dielectric layer 3.

A protective layer 7, made e.g. of a laser-light transparent UV curable resin having a thickness of 100 μm is present adjacent the first dielectric layer 3. Spincoating and subsequent UV curing may provide layer 7.

Sputtering provides the layers 3, 4, 5, and 6. The initial crystalline state of the recording layer 4 is obtained by heating the as-deposited amorphous recording layer 4 in a recorder by means of a continuous laser-light beam to above its crystallization temperature.

Table 1 summarizes the results of examples according to the invention, wherein the composition of the Ga-In-Sb alloy has been varied.

TABLE 1

| | | | | | Extrapolated |
|---|---|---|---|---|---|
| | | | | | data stability (t_{c}) |
| | Ga | In | Sb | CET | at 30° C. |
| Example | (at. %) | (at. %) | (at. %) | (ns) | (years) |
| C | 25 | 25 | 50 | 25 | >1000 |
| D | 37.5 | 12.5 | 50 | 11 | >>1000 |
| G | 27.5 | 27.5 | 45 | 8 | 65 |
| H | 48 | 12 | 40 | 7 | 26 |

All examples C, D, G, and H have an Rₐ and R_{c} at λ=670 nm of 16% and 6% respectively. The examples C, D, G, and H are situated within the quadrangular area in the ternary composition diagram Ga-In-Sb in FIG. 1. The area has the following vertices T, U, V and W:

| | |
|---|---|
| Ga₃₆In₁₀Sb₅₄ | (T) |
| Ga₁₀In₃₆Sb₅₄ | (U) |
| Ga₂₆In₃₆Sb₃₈ | (V) |
| Ga₅₂In₁₀Sb₃₈ | (W). |

When in example D the material of the first dielectric layer 3, which is present adjacent the recording layer 4, is replaced by the compound SiH_{0.1}, its thickness is decreased to 65 nm and the recording layer thickness is increased to 31 nm, the amorphous reflection Rₐ increases to 21%. This has the additional advantage that the optical contrast is higher. Furthermore the CET is shortened from 11 to 7 ns because of the larger thickness of the recording layer 4. In this case the amorphous reflection is larger than the crystalline reflection. This is generally referred to as low to high modulation.

It is also possible to obtain high to low modulation, in which case written amorphous marks have a lower reflection than their crystalline surroundings. A stack 2 having a 30 nm (or 117 nm) thick first dielectric layer 3 of SiH_{0.1}, a 31 nm thick recording layer 4 of composition D, a 20 nm thick second dielectric layer 5 made of (ZnS)₈₀(SiO₂)₂₀ and a 100 nm thick metal reflection layer 6 made of Ag has an Rₐ of 6% and an R_{c} of 21%, which is exactly the inverse contrast compared to the stack described in the previous paragraph.

In FIG. 3 the rewritable optical data storage medium 20 for high-speed recording by means of a laser-light beam 10 has a substrate 1 and a stack 2 of layers provided thereon. The stack 2 has a first dielectric layer 3 made of (ZnS)₈₀(SiO₂)₂₀ having a thickness of 117 μm, a second dielectric layer 5 made of (ZnS)80(SiO₂)₂₀ having a thickness of 17 nm and a recording layer 4 of a phase-change material having an alloy comprising Ga, In and Sb. The recording layer 4, having a thickness of 25 nm, is interposed between the first dielectric layer 3 and the second dielectric layer 5. The recording layer 4 is in contact with two additional SiC layers 3′ and 5′, each having a thickness of 3 μm. The ratio of Ga, In and Sb in the alloy is represented by a point C, D, G and H in the ternary composition diagram of FIG. 1. The exact compositions are indicated in Table 1. For such a stack with a recording layer 4 of the composition as in example C, the CET is measured to be 12 ns, which is substantially shorter than the CET of 25 ns of the rewritable optical data storage medium of FIG. 2, in which no additional SiC layers 3′ and 5′ are present. The thickness of dielectric layers 3 and 5 is reduced by 3 nm in order to keep the total thickness of SiC layers 3′ and 5′ and dielectric layers 3 or 5 constant.

FIG. 4 shows a graph of the measured data stability or crystallization time (t_{c}) at relatively high temperatures (in ° C.) of the alloys A, B, C, G, H, I and J. D, E and F have a data stability of much more than 1000 years at 30° C. and are not shown in FIG. 4. By extrapolation the stability at lower temperatures is estimated. The extrapolation curve is based on the assumption that the crystallization time is logarithmically dependent on the inverse absolute temperature (in K). The crystallization behavior is measured on written marks. Normally the stability is based on the as deposited amorphous state, which however generally leads to a too high value of the stability. This is because the written amorphous marks contain many more nucleation sites than the as deposited amorphous state layer, which increases the crystallization speed. For the written mark crystallization behavior measurements the following procedure was used. Stacks were sputtered on glass substrates and the flat parts of the discs were initialized with a laser. DVD density carriers were written continuously in a spiral manner in the initialized parts. Pieces cut from the disc were placed in a furnace and the amorphous marks were subsequently crystallized at a specific temperature while monitoring the reflection with a large laser spot (λ=670 nm).

### COMPARATIVE EXAMPLES A, B, E, F, I and J

### Not According to the Invention

Table 2 summarizes the results of examples not according to the invention.

TABLE 2

| | | | | | Extrapolated |
|---|---|---|---|---|---|
| | | | | | data stability (t_{c}) |
| | Ga | In | Sb | CET | at 30° C. |
| Example | (at. %) | (at. %) | (at. %) | (ns) | (years) |
| A | 0 | 50 | 50 | 65 | 0.02 |
| B | 12.5 | 37.5 | 50 | 17 | 3 |
| E | 50 | 0 | 50 | 7 | >>1000 |
| F | 22.5 | 22.5 | 55 | 73 | >1000 |
| I | 56 | 10 | 34 | 7 | 0.07 |
| J | 10 | 40 | 50 | 25 | 0.6 |

Examples A, B, I and J show a stability lower than 10 years at 30° C. Examples E and F do have a stability which is higher than 10 years at 30° C. but have the respective disadvantages of having a low laser-light writing sensitivity and a high CET. The compositions of table 2 are situated outside the area of quadrangle TUVW.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

According to the invention, a rewritable phase-change optical data storage medium is provided with a data stability of 10 years or more at 30° C., and which is suitable for direct overwrite and high-speed recording, such as e.g. CD-RW high speed, DVD+RW, DVD−RW, DVD-RAM, DVD-red and -blue.

1. A rewritable optical data storage medium (20) for high-speed recording by means of a laser-light beam (10), said medium (20) comprising a substrate (1) carrying a stack (2) of layers, which stack (2) comprises, a first dielectric layer (3), a second dielectric layer (5), and a recording layer (4) of a phase-change material having an alloy comprising Ga, In and Sb, said recording layer (4) being interposed between the first dielectric layer (3) and the second dielectric layer (5), characterized in that the ratio of Ga, In and Sb in the alloy is represented by an area in the ternary composition diagram (30) Ga-In-Sb in atomic percentages, said area being of quadrangular shape having the following vertices T, U, V and W:

| | |
|---|---|
| Ga₃₆In₁₀Sb₅₄ | (T) |
| Ga₁₀In₃₆Sb₅₄ | (U) |
| Ga₂₆In₃₆Sb₃₈ | (V) |
| Ga₅₂In₁₀Sb₃₈ | (W). |

2. An optical data storage medium (20) as claimed in claim 1, characterized in that the ratio of Ga, In and Sb in the alloy is represented by an area in the ternary composition diagram (30) Ga-In-Sb in atomic percentages, said area being of quadrangular shape having the following vertices T, X, Y and Z:

| | |
|---|---|
| Ga₃₆In₁₀Sb₅₄ | (T) |
| Ga₁₄In₃₂Sb₅₄ | (X) |
| Ga₂₅In₃₂Sb₄₃ | (Y) |
| Ga₄₇In₁₀Sb₄₃ | (Z). |

3. An optical data storage medium (20) as claimed in any one of claim 1 or 2, characterized in that the first dielectric layer (3) comprises the compound SiH_{y} and is present adjacent the recording layer (4), and in which y satisfies 0≦y≦0.5.

4. An optical data storage medium (20) as claimed in claim 3, characterized in that the recording layer (4) has a thickness of at least 30 nm.

5. An optical data storage medium (20) as claimed in any one of claims 1-4, characterized in that the recording layer (4) is in contact with at least one additional carbide layer (3′, 5′), having a thickness between 2 and 8 nm.

6. An optical data storage medium as claimed in claim 5, characterized in that the carbide layer (3′, 5′) comprises SiC.

7. An optical data storage medium as claimed in any one of claims 1-6, characterized in that a metal reflective layer (6) is present adjacent the second dielectric layer (5) at a side remote from the first dielectric layer (3).

8. An optical data storage medium (20) as claimed in claim 7, characterized in that the metal reflective layer (6) comprises at least one of the metals selected from a group consisting of Al, Ti, Au, Ag, Cu, Pt, Pd, Ni, Cr, Mo, W and Ta, including alloys of these metals.

9. Use of an optical data storage medium (20) according to any one of claims 1-8 for high data rate and high data stability recording.
